(19) United States
(12) Patent Application Publication
(10) Pub. No.: US 2023/0136314 A1
(43) Pub. Date: May 4, 2023

(54) DEEP LEARNING BASED WHITE BALANCE CORRECTION OF VIDEO FRAMES

(71) Applicant: Polycom Communications Technology (Beijing) Co., Ltd., Beijing (CN)

(72) Inventors: Tianran WANG, Beijing (CN); Hai XU, Beijing (CN); Xingyue HUANG, Beijing (CN); Yongkang FAN, Beijing (CN); Wenxue HE, Beijing (CN)

(73) Assignee: Polycom Communications Technology (Beijing) Co., Ltd., Beijing (CN)

(21) Appl. No.: 17/912,024

(22) PCT Filed: May 12, 2020
(86) PCT No.: PCT/CN2020/089751

§ 371 Date: Sep. 15, 2022

(51) Int. Cl. G06T 7/90; H04N 9/73

(52) U.S. Cl. CPC G06T 7/90; H04N 9/73; G06T 2207/10016

(57) ABSTRACT

A method may include calculating a color gain by applying an automatic white balance (AWB) algorithm to a video frame of a video feed, calculating an illumination color by applying a machine learning model to the video frame, transforming the illumination color into an equivalent color gain, determining that a difference between the color gain and the equivalent color gain exceeds a difference threshold, reversing an effect of the illumination color on the video frame based on the threshold being exceeded to obtain a corrected video frame, and transmitting the corrected video frame to an endpoint.

### BACKGROUND

Automatic white balance (AWB) algorithms adjust the rendering of neutral (e.g., white) colors to accurately represent the actual neutral colors in a scene targeted by a camera lens. Traditional AWB algorithms are based on analysis of pixel values and assumptions regarding average color in a frame. For example, the white points algorithm assumes that there are always white regions in frame, and the majority of white-like regions should be white. Accurate processing of background colors using traditional AWB algorithms remains an unsolved problem. Traditional AWB algorithms measure what is displayed in an image, but do not recognize and understand the image. For example, a cream-colored desk is not distinguished from a pure white desk which looks cream-colored when illuminated under warm light. While human vision corrects color based on recognition of objects, it is not feasible to apply machine learning-based white balance algorithms when quick (e.g., real-time) performance is required, such as in the case of video streaming.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including calculating a color gain by applying an automatic white balance (AWB) algorithm to a video frame of a video feed, calculating an illumination color by applying a machine learning model to the video frame, transforming the illumination color into an equivalent color gain, determining that a difference between the color gain and the equivalent color gain exceeds a difference threshold, reversing an effect of the illumination color on the video frame based on the difference threshold being exceeded to obtain a corrected video frame, and transmitting the corrected video frame to an endpoint.

In general, in one aspect, one or more embodiments relate to a system including a camera including an image signal processor (ISP) configured to calculate a color gain by applying an automatic white balance (AWB) algorithm to a video frame of a video feed, transform an illumination color into an equivalent color gain, determine that a difference between the color gain and the equivalent color gain exceeds a difference threshold, and reverse an effect of the illumination color on the video frame based on the difference threshold being exceeded to obtain a corrected video frame. The system further includes a video module including a machine learning model, the video module configured to calculate the illumination color by applying the machine learning model to the video frame and transmit the corrected video frame to an endpoint.

In general, in one aspect, one or more embodiments relate to a method including calculating a color gain by applying an automatic white balance (AWB) algorithm to a video frame of a video feed, applying the color gain to the video frame to obtain a first corrected video frame, calculating an illumination color by applying a machine learning model to the first corrected video frame, transforming the illumination color into an equivalent color gain, determining that a difference between the color gain and the equivalent color gain exceeds a difference threshold, reversing an effect of the illumination color on the first corrected video frame based on the difference threshold being exceeded to obtain a second corrected video frame, and transmitting the second corrected video frame to an endpoint.

Other aspects of the invention will be apparent from the following description and the appended claims.

### BRIEF DESCRIPTION OF DRAWINGS

FIG. 1 shows an operational environment of embodiments of this disclosure.

FIG. 2 and FIG. 3 show components of the operational environment of FIG. 1.

FIG. 4.1 and FIG. 4.2 show flowcharts of methods in accordance with one or more embodiments of the disclosure.

FIG. 5.1, FIG. 5.2, and FIG. 6 show examples in accordance with one or more embodiments of the disclosure.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, although the description includes a discussion of various embodiments of the disclosure, the various disclosed embodiments may be combined in virtually any manner. All combinations are contemplated herein.

In the drawings and the description of the drawings herein, certain terminology is used for convenience only and is not to be taken as limiting the embodiments of the present disclosure. In the drawings and the description below, like numerals indicate like elements throughout.

Images captured using a lens include inaccuracies in color balance. Embodiments of the disclosure are generally directed to white balance correction of video frames. In one or more embodiments, a color gain is calculated by applying an automatic white balance (AWB) algorithm to a video frame of a video feed. The AWB algorithm adjusts the rendering of neutral (e.g., white, cream, and other such neutral) colors in a video frame. The adjustment is performed so that neutral colors shown in a corrected video frame accurately represent actual neutral colors in the scene targeted by the lens of a camera. The adjustment to the video frame by the AWB algorithm is called the color gain. In one or more embodiments, an image signal processor (ISP) of the camera may apply the AWB algorithm to the video frame.

Further, embodiments apply a machine learning model to the video frame to obtain an illumination color. The illumination color represents a bias in the video frame due to illumination from a light source.

While the machine learning model is more precise than the AWB algorithm, applying the machine learning model incurs substantial computational overhead. The computational overhead may be reduced by having the machine learning model calculate the illumination color after the color gain has stabilized. For example, the color gain may be unstable after a change in illumination of the scene captured by the camera. Continuing this example, the change in illumination may be due to turning a light switch on or off in a meeting room hosting a conferencing endpoint. When the difference between the color gain and an equivalent color gain derived from the illumination color exceeds a difference threshold, the equivalent color gain is used to generate a corrected video frame from the video frame. Triggering the activity of the machine learning model at regular intervals and/or triggering the activity of the machine learning model when the color gain is stable reduces the computational overhead and latency that would be incurred if the machine learning model were continuously active. Disclosed are systems and methods for white balance correction of video frames. While the disclosed systems and methods are described in connection with a teleconference system, the disclosed systems and methods may be used in other contexts according to the disclosure.

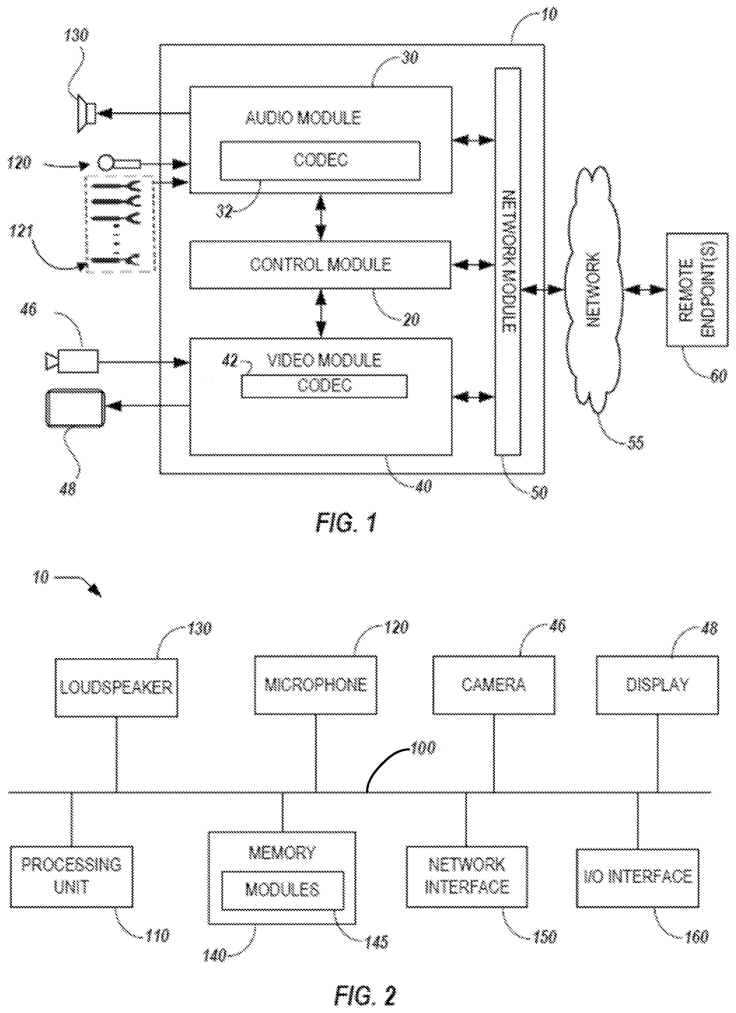

FIG. 1 illustrates a possible operational environment for example circuits of this disclosure. Specifically, FIG. 1 illustrates a conferencing apparatus or endpoint (10) in accordance with an embodiment of this disclosure. The conferencing apparatus or endpoint (10) of FIG. 1 communicates with one or more remote endpoints (60) over a network (55). The endpoint (10) includes an audio module (30) with an audio codec (32), and a video module (40) with a video codec (42). These modules (30, 40) operatively couple to a control module (20) and a network module (50). The modules (30, 40, 20, 50) include dedicated hardware, software executed by one or more hardware processors, or a combination thereof. In some examples, the video module (40) corresponds to a graphics processing unit (GPU), a neural processing unit (NPU), software executable by the graphics processing unit, a central processing unit (CPU), software executable by the CPU, or a combination thereof. In some examples, the control module (20) includes a CPU, software executable by the CPU, or a combination thereof. In some examples, the network module (50) includes one or more network interface devices, a CPU, software executable by the CPU, or a combination thereof. In some examples, the audio module (30) includes, a CPU, software executable by the CPU, a sound card, or a combination thereof.

In general, the endpoint (10) can be a conferencing device, a videoconferencing device, a personal computer with audio or video conferencing abilities, or any similar type of communication device. The endpoint (10) is configured to generate near-end audio and video and to receive far-end audio and video from the remote endpoints (60). The endpoint (10) is configured to transmit the near-end audio and video to the remote endpoints (60) and to initiate local presentation of the far-end audio and video.

A microphone (120) captures audio and provides the audio to the audio module (30) and codec (32) for processing. The microphone (120) can be a table or ceiling microphone, a part of a microphone pod, an integral microphone to the endpoint, or the like. Additional microphones (121) can also be provided. Throughout this disclosure, all descriptions relating to the microphone (120) apply to any additional microphones (121), unless otherwise indicated. The endpoint (10) uses the audio captured with the microphone (120) primarily for the near-end audio. A camera (46) captures video and provides the captured video to the video module (40) and video codec (42) for processing to generate the near-end video. For each video frame of near-end video captured by the camera (46), the control module (20) selects a view region, and the control module (20) or the video module (40) crops the video frame to the view region. In general, a video frame (i.e., frame) is a single still image in a video feed, that together with the other video frames form the video feed. The view region may be selected based on the near-end audio generated by the microphone (120) and the additional microphones (121), other sensor data, or a combination thereof. For example, the control module (20) may select an area of the video frame depicting a participant who is currently speaking as the view region. As another example, the control module (20) may select the entire video frame as the view region in response to determining that no one has spoken for a period of time. Thus, the control module (20) selects view regions based on a context of a communication session.

After capturing audio and video, the endpoint (10) encodes it using any of the common encoding standards, such as MPEG-1, MPEG-2, MPEG-4, H.261, H.263 and H.264. Then, the network module (50) outputs the encoded audio and video to the remote endpoints (60) via the network (55) using any appropriate protocol. Similarly, the network module (50) receives conference audio and video via the network (55) from the remote endpoints (60) and sends these to their respective codec (32, 42) for processing. Eventually, a loudspeaker (130) outputs conference audio (received from a remote endpoint), and a display (48) can output conference video.

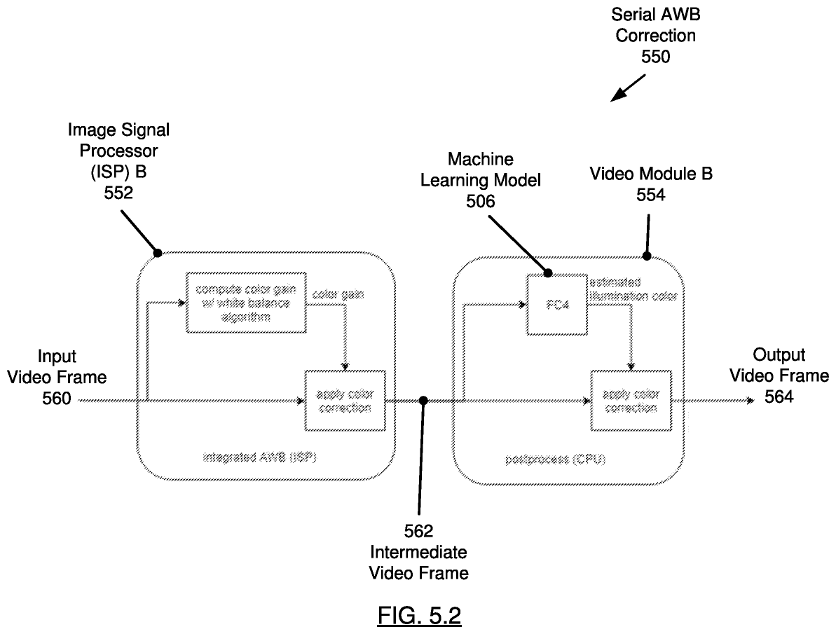

Thus, FIG. 1 illustrates an example of a device that adjusts white balance in video captured by a camera. In particular, the device of FIG. 1 may operate according to one of the methods described further below with reference to FIG. 4.1 and FIG. 4.2. As described below, these methods may improve the accuracy of white balance in video during a communication session.

FIG. 2 illustrates components of the conferencing endpoint of FIG. 1 in detail. The endpoint (10) has a processing unit (110), memory (140), a network interface (150), and a general input/output (I/O) interface (160) coupled via a bus (100). As above, the endpoint (10) has the base microphone (120), loudspeaker (130), the camera (46), and the display (48).

The processing unit (110) includes a CPU, a GPU, an NPU, or a combination thereof. The memory (140) can be any conventional memory such as SDRAM and can store modules (145) in the form of software and firmware for controlling the endpoint (10). The stored modules (145) include the codec (32, 42) and software components of the other modules (20, 30, 40, 50) discussed previously. Moreover, the modules (145) can include operating systems, a graphical user interface (GUI) that enables users to control the endpoint (10), and other algorithms for processing audio/video signals.

The network interface (150) provides communications between the endpoint (10) and remote endpoints (60). By contrast, the general I/O interface (160) can provide data transmission with local devices such as a keyboard, mouse, printer, overhead projector, display, external loudspeakers, additional cameras, microphones, etc.

As described above, the endpoint (10) captures video frames of video and adjusts white balance in the captured video frames. Thus, FIG. 2 illustrates an example physical configuration of a device that corrects white balance inaccuracies to enhance quality of a video.

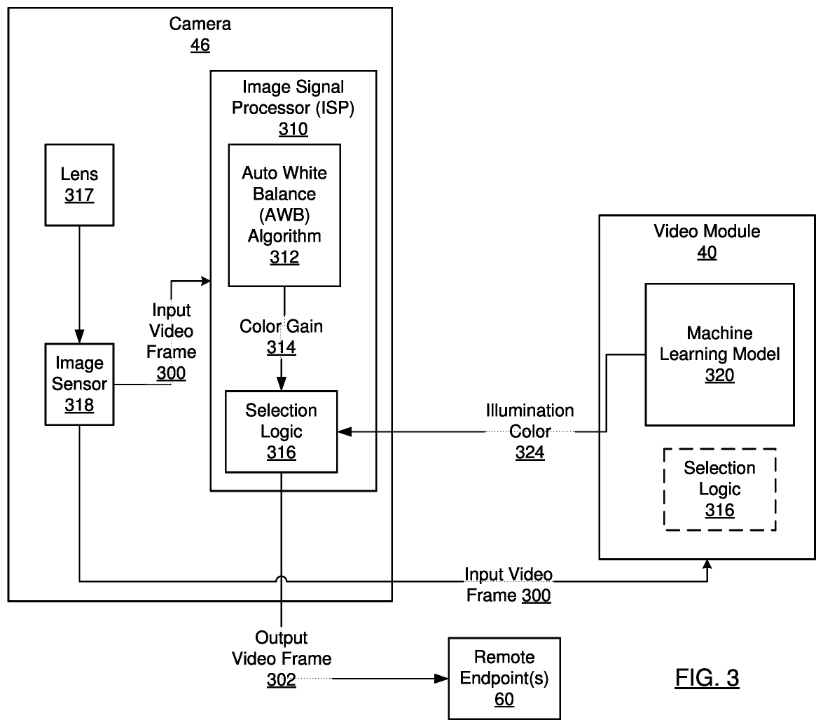

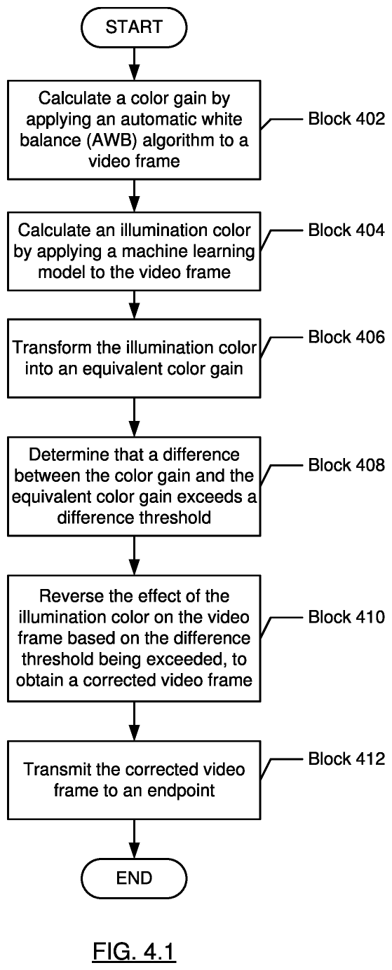

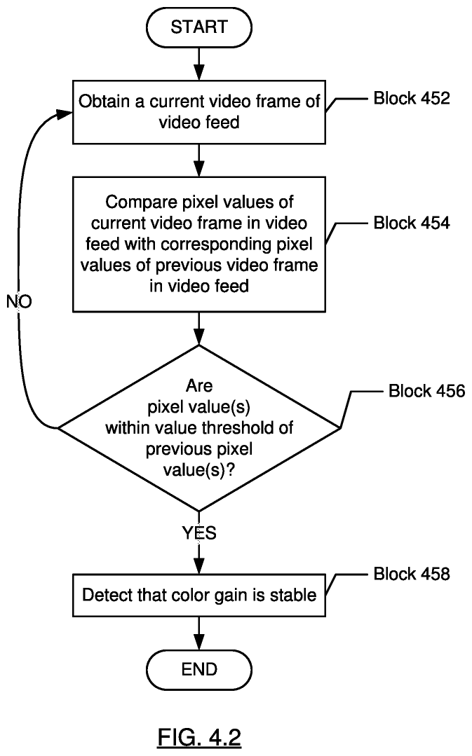

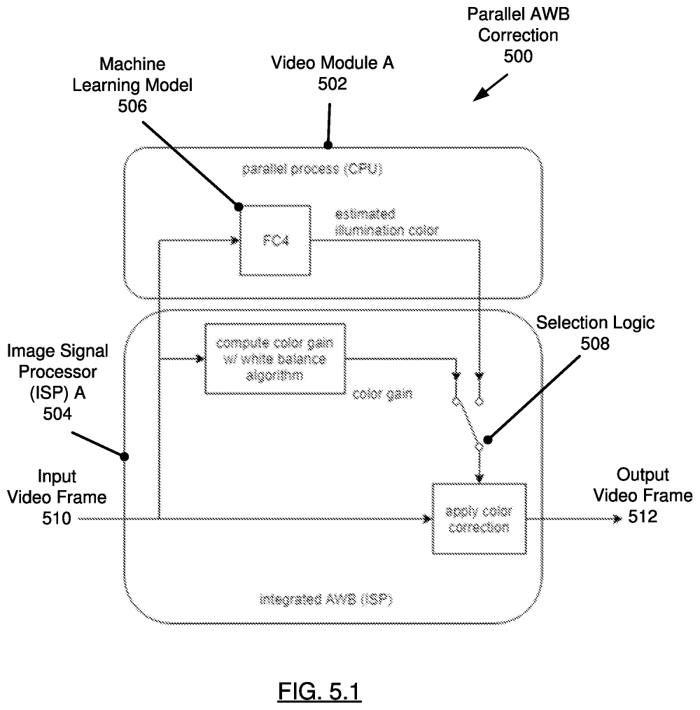

As shown in FIG. 3, in one or more embodiments, the camera (46) includes an image signal processor (ISP) (310), a lens (317), and an image sensor (318). The image sensor (318) via the lens (317) includes functionality to capture an image in a video feed from a scene. For example, the scene may be a meeting room that includes a conferencing endpoint (10). For example, the image sensor (318) may represent the image in a digital format. The input video frame (300) may be a video frame in a series of video frames captured from the video feed.

The ISP (310) may include a processor used for image processing in digital cameras and/or other devices. The ISP (310) includes functionality to generate an output video frame (302) that corrects a white imbalance in a corresponding input video frame (300). The ISP (310) includes an automatic white balance (AWB) algorithm (312) and selection logic (316). The AWB algorithm (312) may be any algorithm that adjusts the rendering of neutral (e.g., white) colors in an input video frame (300) so that neutral colors accurately represent the actual neutral colors in the scene targeted by the lens (318). The adjustment to the input video frame (300) by the AWB algorithm (312) is called the color gain (314). The color gain (314) may be represented as a vector that includes red, green, and blue (rgb) components.

The selection logic (316) includes functionality to select between the color gain (314) calculated by the AWB algorithm (312) and an illumination color (324) calculated by a machine learning model (320). The selection logic (316) may include a timer (not shown). In one or more embodiments, the timer includes functionality to activate or otherwise trigger the machine learning model (320) at regular intervals. The selection logic (316) may include functionality to generate an output video frame (302) using the color gain (314) and/or the illumination color (324). The selection logic (316) may include functionality to send the output video frame (302) to one or more remote endpoints (60).

As shown in FIG. 3, in one or more embodiments, the video module (40) includes a machine learning model (320). The video module (40) optionally may include the selection logic (316), such as the selection logic described above with reference to FIG. 3. In one or more embodiments, the video module (40) may implement the selection logic (316). For example, it may be infeasible for the ISP (310) to perform the selection logic (316). The video module (40) may include functionality to generate the output video frame (302) based on receiving an intermediate video frame from the ISP (310) and transmit the output video frame (302) to the remote endpoint. For example, the intermediate video frame may be generated by the ISP (310) using the color gain (314) and the output video frame may be generated by the video module (40) using the illumination color (324).

The machine learning model (320) may be a deep learning model that includes functionality to generate (e.g., estimate) an illumination color (324) from an input video frame (300). The illumination color (324) represents a bias in the input video frame (300) due to illumination from a light source. The illumination color (324) may be represented as an rgb vector that includes red, green, and blue components. As an example, the rgb vector may be (0.8447622, 0.9065292, 1.703821). In one or more embodiments, the machine learning model (320) applies a normalization function to the components of the rgb vector.

The machine learning model (320) may be the open source FC4 deep learning model. The FC4 model may learn a global understanding of the input video frame (300) and generate a confidence map with weights allocated to colors in different regions of the input video frame (300). The highest weighted regions may be the white/grey regions that are commonly used in traditional AWB algorithms, as well as regions with easy identifiable color, such as human face. The FC4 deep learning model estimates the overall illumination color (324) for the input video frame (300) based on separate estimations of illumination color in selected regions.

FIG. 4.1 shows a flowchart in accordance with one or more embodiments of the invention. The flowchart depicts a process for white balance correction of a video frame. One or more of the steps in FIG. 4.1 may be performed by the components (e.g., the video module (40) and image signal processor (ISP) (310)), discussed above in reference to FIG. 3. In one or more embodiments of the invention, one or more of the steps shown in FIG. 4.1 may be omitted, repeated, and/or performed in parallel, or in a different order than the order shown in FIG. 4.1. Accordingly, the scope of the invention should not be considered limited to the specific arrangement of steps shown in FIG. 4.1.

Initially, in Block 402, a color gain is calculated by applying an automatic white balance (AWB) algorithm to a video frame of a video feed. The video feed may be captured using a wide-angle lens and image sensor of a camera. The ISP may apply the AWB algorithm to the video frame to calculate the color gain.

In Block 404, an illumination color is calculated by applying a machine learning model to the video frame. The machine learning model may calculate the illumination color after the stabilization of the color gain has been detected (see description of FIG. 4.2 below for detecting stabilization of color gain). For example, the color gain may be unstable while the AWB algorithm processes a change in illumination of the scene captured by the camera. Continuing this example, the change in illumination may be due to turning a light switch on or off in a meeting room hosting a conferencing endpoint. Changes in illumination may be infrequent at a conferencing endpoint. In one or more embodiments, the stabilization of the color gain is detected after a change in illumination exceeds an illumination threshold. The ISP may detect a change in illumination by monitoring the color gain calculated by the AWB. If the change in the color gain exceeds a gain threshold within a predetermined time interval, then the ISP may conclude that the illumination is changing. Once the color gain has stabilized, the ISP may conclude that the illumination has also stabilized. Alternatively, the ISP may detect a change in illumination by comparing pixel values in successive video frames. For example, the ISP may compare the average grey value of the successive video frames.

In one or more embodiments, the machine learning model calculates the illumination color at regular intervals after the stabilization of the color gain is detected. For example, a timer may be used to trigger, at regular intervals, the calculation of the illumination color by the machine learning model. Continuing this example, the calculation of the illumination color by the machine learning model may be triggered at 30 second intervals after detecting the stabilization of the color gain. Triggering the activity of the machine learning model at regular intervals and/or triggering the activity of the machine learning model after detecting the stabilization of the color gain reduces the computational overhead and latency that would be incurred if the machine learning model was continuously active. Thus, while Step 402 may be continually performed for video frames in a video feed, Step 404 may be performed when triggered.

In Block 406, the illumination color is transformed into an equivalent color gain. The selection logic may apply a transformation formula to the illumination color to obtain the equivalent color gain. In one or more embodiments, the transformation formula multiplies the average of the components (e.g., red, green, and blue components) of the illumination color, divided by the magnitude of the illumination color to obtain the equivalent color gain. The equivalent color gain may be thought of as the “reverse” of the illumination color. The equivalent color gain may be used to suppress the effect of the illumination color, as described in Block 410 below. The transformation formula may be updated when the color gain stabilizes after a change in illumination.

In Block 408, it is determined that a difference between the color gain and the equivalent color gain exceeds a difference threshold. The selection logic may compare the equivalent color gain to the color gain calculated by the ISP in Block 402 above. The comparison of the equivalent color gain and the color gain calculated by the ISP may be performed in response to detecting the stabilization of the color gain (see description of FIG. 4.2 below).

In Block 410, the effect of the illumination color on the video frame is reversed based on the difference threshold being exceeded to obtain a corrected video frame. The effect of the illumination color may be reversed by multiplying the pixel values in the video frame by the equivalent color gain calculated in Block 406 above.

In one or more embodiments, the selection logic assumes that the color gain calculated by the ISP in Block 402 above is inaccurate when the difference between the color gain calculated by the ISP and the equivalent color gain exceeds the difference threshold, and thus the equivalent color gain, rather than the color gain calculated by the ISP, is used to correct the video frame. Alternatively, when the difference between the color gain calculated by the ISP and the equivalent color gain does not exceed the difference threshold, the color gain calculated by the ISP is used to correct the video frame.

In Block 412, the corrected video frame is transmitted to an endpoint. The endpoint may be an endpoint that is remote with respect to the conferencing apparatus (e.g., accessible over a network). Alternatively, the endpoint may be local with respect to the conferencing apparatus endpoint (e.g., a display device).

FIG. 4.2 shows a flowchart in accordance with one or more embodiments of the invention. The flowchart depicts a process for detecting that a color gain is stable. One or more of the steps in FIG. 4.2 may be performed by the components (e.g., the video module (40) and image signal processor (ISP) (310)), discussed above in reference to FIG. 3. In one or more embodiments of the invention, one or more of the steps shown in FIG. 4.2 may be omitted, repeated, and/or performed in parallel, or in a different order than the order shown in FIG. 4.2. Accordingly, the scope of the invention should not be considered limited to the specific arrangement of steps shown in FIG. 4.2.

Initially, in Block 452, a current video frame of a video feed is obtained. The video feed may be captured using a lens and image sensor of a camera.

In Block 454, values of one or more pixels in a current video frame in the video feed are compared to values of corresponding pixels in a previous video frame in the video feed. For example, the red, green and/or blue values of the pixels may be compared. In one or more embodiments, comparing the pixel values is performed after a change in illumination is detected. Alternatively, a moving average of pixel values of a series of previous video frames may be calculated and compared. For example, a circular buffer may be used to store a fixed number of recent video frames, such that the moving average is calculated using the pixel values of the video frames in the circular buffer.

If, in Block 456, it is determined that the current and previous pixel values are within a value threshold, then in Block 458 a stable color gain is detected. Alternatively, a stable color gain may be detected when a color gain calculated for the current video frame is within a gain threshold of a color gain calculated for the previous video frame. In one or more embodiments, the color gain calculated for a video frame may be extracted via an application programming interface (API) of the ISP.

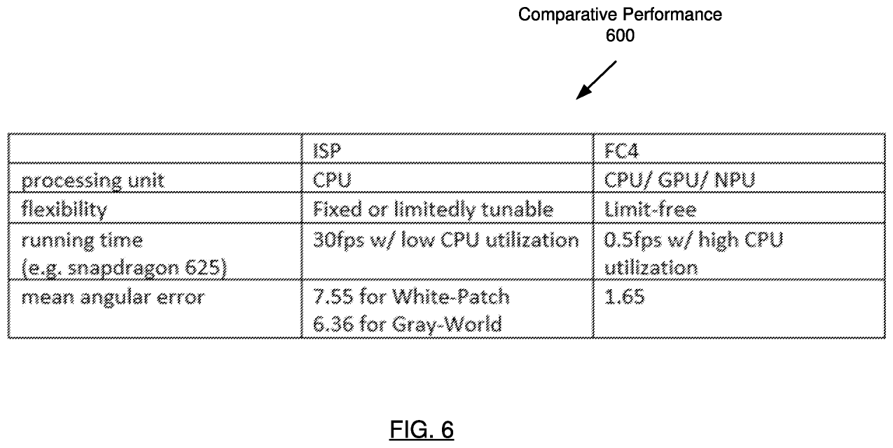

FIG. 5.1 and FIG. 5.2 show an implementation example(s) in accordance with one or more embodiments. The implementation example(s) are for explanatory purposes only and not intended to limit the scope of the invention. One skilled in the art will appreciate that implementation of embodiments of the invention may take various forms and still be within the scope of the invention.

FIG. 5.1 shows a parallel AWB correction (500) embodiment where a machine learning model (506) ((320) in FIG. 3) of a video module (502) ((40) in FIG. 3) performs AWB correction in parallel with an image signal processor (ISP) (504) ((310) in FIG. 3). The ISP (504) includes selection logic (508) ((316) in FIG. 3) that selects between the illumination color calculated by the machine learning model (506) and the color gain calculated by the ISP (504). An input video frame (510) is converted to an output video frame (512) by applying either the illumination color or the color gain to the input video frame (510), depending on the selection made by the selection logic (508). The selection logic (508) compares the color gain with the illumination color after detecting the stability of the color gain.

FIG. 5.2 shows a serial AWB correction (550) embodiment where an image signal processor (ISP) (552) generates an intermediate video frame (562) by applying a color gain to an input video frame (560). Then, an illumination color calculated by a machine learning model (506) of a video module (554) is applied to the intermediate video frame (562) to generate an output video frame (564). The serial AWB correction (550) is simple to implement, since it is unnecessary to modify the ISP (552) to include selection logic. To reduce computational overhead, the machine learning model (506) is triggered to calculate the illumination color at regular intervals once the color gain calculated by the ISP (552) is stable. In this example, the machine learning model (506) is triggered at 30-second intervals.

FIG. 6 shows the comparative performance (600) of the AWB algorithms performed by the ISP and the machine learning model, in this case, the FC4 model. The running time of the machine learning model is significantly slower than the running time of the ISP. Thus, it is desirable to reduce computational overhead by reducing the frequency of triggering the calculations of the machine learning model.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
calculating a first color gain by applying an automatic white balance (AWB) algorithm to a video frame of a video feed;
calculating an illumination color by applying a machine learning model to the video frame;
transforming the illumination color into an equivalent color gain;
determining that a difference between the first color gain and the equivalent color gain exceeds a difference threshold;
reversing an effect of the illumination color on the video frame based on the difference threshold being exceeded to obtain a corrected video frame; and
transmitting the corrected video frame to an endpoint.

2. The method of claim 1, wherein determining that the difference between the first color gain and the equivalent color gain exceeds the difference threshold is performed by an image signal processor (ISP) of a camera.

3. The method of claim 1, further comprising:
detecting that the first color gain has stabilized,
wherein determining that the difference between the first color gain and the equivalent color gain exceeds the difference threshold is performed in response to detecting that the first color gain has stabilized.

4. The method of claim 3, wherein detecting that the first color gain has stabilized comprises:
obtaining a current video frame of the video feed; and
determining that a current value of a pixel in the current video frame is within a value threshold of a previous value of the pixel in a previous video frame of the video feed.

5. The method of claim 3, wherein detecting that the first color gain has stabilized comprises determining that a current value of the first color gain is within a gain threshold of a previous value of the first color gain.

6. The method of claim 3, wherein the illumination color is calculated in response to detecting that the first color gain has stabilized.

7. The method of claim 3, wherein the illumination color is calculated at regular intervals after detecting that the first color gain has stabilized.

8. A system, comprising:
a camera comprising an image signal processor (ISP) configured to:
calculate a first color gain by applying an automatic white balance (AWB) algorithm to a video frame of a video feed,
transform an illumination color into an equivalent color gain,
determine that a difference between the first color gain and the equivalent color gain exceeds a difference threshold, and
reverse an effect of the illumination color on the video frame based on the difference threshold being exceeded to obtain a corrected video frame; and
a video module comprising a machine learning model and configured to:
calculate the illumination color by applying the machine learning model to the video frame, and
transmit the corrected video frame to an endpoint.

9. The system of claim 8, wherein the ISP is further configured to:
detect that the first color gain has stabilized,
wherein detecting that the difference between the first color gain and the equivalent color gain exceeds the difference threshold is performed in response to detecting that the first color gain has stabilized.

10. The system of claim 9, wherein the ISP is further configured to detect that the first color gain has stabilized by:
obtaining a current video frame of the video feed, and
determining that a current value of a pixel in the current video frame is within a value threshold of a previous value of the pixel in a previous video frame of the video feed.

11. The system of claim 9, wherein the ISP is further configured to detect that the first color gain has stabilized by:
determining that a current value of the first color gain is within a gain threshold of a previous value of the first color gain.

12. The system of claim 9, wherein the video module calculates the illumination color after the ISP detects that the first color gain has stabilized.

13. The system of claim 9, wherein the video module calculates the illumination color at regular intervals after the ISP detects that the first color gain has stabilized.

14. A method, comprising:
calculating a first color gain by applying an automatic white balance (AWB) algorithm to a video frame of a video feed;
applying the first color gain to the video frame to obtain a first corrected video frame;
calculating an illumination color by applying a machine learning model to the first corrected video frame;
transforming the illumination color into an equivalent color gain;
determining that a difference between the first color gain and the equivalent color gain exceeds a difference threshold;
reversing an effect of the illumination color on the first corrected video frame based on the difference threshold being exceeded to obtain a second corrected video frame; and
transmitting the second corrected video frame to an endpoint.

15. The method of claim 14, wherein determining that the difference between the first color gain and the equivalent color gain exceeds the difference threshold is performed by a machine learning model of a video module.

16. The method of claim 14, further comprising:
detecting that the first color gain has stabilized,
wherein determining that the difference between the first color gain and the equivalent color gain exceeds the difference threshold is performed in response to detecting that the first color gain has stabilized.

17. The method of claim 16, wherein detecting that the first color gain has stabilized comprises:
obtaining a current video frame of the video feed; and
determining that a current value of a pixel in the current video frame is within a value threshold of a previous value of the pixel in a previous video frame of the video feed.

18. The method of claim 16, wherein detecting that the first color gain has stabilized comprises determining that a current value of the first color gain is within a gain threshold of a previous value of the first color gain.

19. The method of claim 16, wherein the illumination color is calculated in response to detecting that the first color gain has stabilized.

20. The method of claim 16, wherein the illumination color is calculated at regular intervals after detecting that the first color gain has stabilized.
